(19) United States
(12) Patent Application Publication
(10) Pub. No.: US 2002/0162458 A1
(43) Pub. Date: Nov. 7, 2002

(54) Effervescent beverage product and method for drinking the same

(75) Inventors: Robert Stanley Farr, Fort Lee, NJ (US); Mark Nicmanis, Bebington (GB)

Correspondence Address: UNILEVER, PATENT DEPARTMENT, 45 RIVER ROAD, EDGEWATER, NJ, 07020, US

(73) Assignee: Unilever Bestfoods, North America

(21) Appl. No.: 10/081,575

(22) Filed: Feb. 22, 2002

(30) Foreign Application Priority Data
Mar. 5, 2001 (EP) 01302000.3
May 23, 2001 (GB) 0112473.4
May 25, 2001 (GB) 0112757.0
Sep. 13, 2001 (GB) 0122150.6

(51) Int. Cl. A23L 1/00; A47J 31/00

(52) U.S. Cl. 99/279; 99/323.3

(57) ABSTRACT

An effervescent beverage having an effervescent gas dissolved therein is described. The beverage remains pressurized until consumed and may have a smooth and silky texture when a sparingly soluble gas is used.

### FIELD OF THE INVENTION

The present invention is directed to a beverage product that comprises a container, dispenser, and a pressurized beverage having a soluble and/or a sparingly soluble effervescent gas dissolved therein. More particularly, the present invention is directed to a beverage product that preferably remains pressurized until substantially all beverage has been consumed.

### BACKGROUND OF THE INVENTION

Carbonated beverages such as mineral water and soft drinks are very popular with consumers. Carbon dioxide is readily soluble in water, (has a solubility of 1.69 g Kg⁻¹ in water at 20° C. and atmospheric pressure), is inexpensive and safe. When carbon dioxide is mixed under pressure with a drinkable liquid in a container, a substantial portion of the gas remains dissolved in the drinkable liquid when the container is opened to the atmosphere and depressurized. Once the container is opened and depressurized, the consumer may then drink the beverage which typically generates a sharp and prickly sensation in the mouth when, for example, swallowing. Moreover, since conventional carbonated beverages are consumed when depressurized, the consumer must use a cumbersome drinking technique that, at the very least, requires at least one hand and a pouring action, or a drinking straw and suckling action in order to drink the carbonated beverage.

Gases that are sparingly soluble in water, such as oxygen or nitrogen, have not been successfully employed in a drinkable liquid in the same manner as more soluble gases, such as carbon dioxide.

Particularly, when oxygen is added to a drinkable liquid under atmospheric conditions, or a container holding a pressurized oxygenated beverage is opened to the atmosphere, a substantial proportion of the oxygen contained in the beverage and packaging will rapidly escape from the beverage and packaging and be dispersed in the surrounding atmosphere, resulting in a poor-tasting and flat (i.e., non-effervescent) beverage. Moreover, since such oxygenated beverages are depressurized prior to consumption, the consumer cannot drink the beverage without at least using one hand and a pouring action, or a drinking straw and a suckling action.

It is of increasing interest to develop a beverage which is good tasting, not flat, effervescent, and smooth and silky in texture, particularly when a sparingly soluble gas is employed. It also is desirable to develop a beverage whereby the beverage may be consumed without requiring the use of at least one hand and a pouring action, or a drinking straw and suckling action, thereby making consumption of the beverage much easier than consumption of conventional beverages, regardless of the type of gas employed (i.e., soluble and/or sparingly soluble). The invention herein, therefore, is directed to an effervescent beverage that, at the very least, is: (a) smooth and silky, or (b) consumable without requiring the use of at least one hand and a pouring action, or a drinking straw and a suckling action, or (c) both. In an especially preferred embodiment, the invention is also directed to a beverage that may be consumed from a beverage product without requiring a hand squeezing action on the container to force the beverage out of the beverage product.

### ADDITIONAL INFORMATION

Efforts have been disclosed for making beverages with oxygen. In JP 64-27458, a health drink with oxygen is described, whereby the package having the health drink is opened and depressurized before the health drink is consumed.

Other efforts have been disclosed for preparing an oxygenated beverage. In U.S. Pat. No. 5,378,480, a method for preparing an oxygenated cocktail is described, whereby the cocktail must be consumed within two minutes of preparation and not under pressure.

Still other efforts have been disclosed for making a drink having improved flavor. In JP 1168269, a water drink having a propellant and an atomizer is described.

None of the information above describes a beverage product whereby a beverage is in a container having a dispenser or valve to dispense the beverage as a water-continuous and effervescent beverage. Moreover, none of the information above describes a pressurized beverage product comprising a beverage that is not only effervescent when dispensed, but also capable of generating a smooth and silky sensation when consumed. Even further, none of the information above describes a liquid-continuous (e.g., water-continuous) beverage whereby the consumer may drink or consume the beverage without requiring the use of at least one hand and a pouring action, or a drinking straw and suckling action to drink the beverage, regardless of the type of gas employed.

### SUMMARY OF THE INVENTION

In a first aspect, the present invention is directed to a pressurized beverage product comprising:

(a) a pressurized beverage within a pressure resistant container, the beverage comprising a soluble gas, a sparingly soluble gas, or a mixture of gases dissolved therein; and

(b) a valve in a position to seal the container, the valve, when opened, suitable to dispense the beverage as an effervescent beverage to a mouth of a consumer

wherein, internally, the container has a headspace pressurized to less than about 25 bar (gauge as measured at about 10° C.) with the soluble gas, sparingly soluble gas, or mixture thereof.

In a second aspect, the present invention is directed to a method for drinking with the pressurized beverage product of the first aspect of this invention.

Beverage, as used herein, is defined to mean a liquid suitable for use in mouth or consumption by humans, including a liquid which may generally be classified as pharmaceutical or medicinal in nature. Effervescent beverage, as used herein, is defined to mean a beverage capable of emitting small bubbles of a gas, and preferably, a beverage which generates a smooth and silky sensation when swallowing, and a beverage which may have a fine, smoke-like appearance when being dispensed as a consequence of the bubbles of gas. Pouring action is meant to mean the conventional mechanical action taken by a consumer when drinking a beverage, like soda, from a bottle (i.e., including head tilting and arm lifting). Beverage product, as used herein, is defined to mean a product that is suitable to dispense a water-continuous liquid, and therefore, a product that preferably does not comprise an atomizer. Smooth and silky, as used herein, is defined to mean the feeling or sensation generated by a beverage comprising bubbles suspended therein, wherein at least 80.0% of the bubbles that are suspended therein have a diameter that is less than about 0.5 mm, and preferably, less than about 0.15 mm. Liquid-continuous beverage means not a fragmented and gas-continuous beverage such as a beverage dispensed from a container having an atomizer.

### BRIEF DESCRIPTION OF THE DRAWINGS

The subject matter which is regarded as the invention is particularly pointed out and distinctly claimed in the concluding portion of the specification. The invention, however, may be best understood by reference to the following description taken in conjunction with the accompanying drawing figures in which:

FIG. 1 depicts an illustrative beverage product of the present invention;

FIG. 2 depicts an illustrative actuator means for use with this invention;

FIGS. 3 and 4 depict an illustrative valve for use with this invention, top view and bottom view, respectively.

### DETAILED DESCRIPTION OF THE PREFERRED EMBODIMENTS

There is no limitation with respect to the type of beverage that may be used in the beverage product of the present invention other than that the beverage is one which may be consumed by humans. Typically, such a beverage is aqueous based or substantially pure water. Examples of the aqueous-based beverages which may be used in this invention include flavored water, with and without minerals (e.g., isotonic sports beverages and energy drinks), vegetable juices, like carrot juice and fruit juices like tomato, strawberry, blueberry, lemon, lime, orange, pineapple juice and mixtures thereof. Other illustrative beverages that may be used in this invention include alcoholic drink (e.g., beer), diet drinks, protein-based drinks (e.g., milk or soy-based), coffee, tea, soda and those beverages which may generally be classified as pharmaceutical or medicinal in nature, including a cough suppressant and a mouthwash. In a preferred embodiment, the beverage is citrus (preferably pulp free) in nature, and most preferably, one comprising at least one flavor (natural and/or artificial) selected from the group consisting of lemon, lime, strawberry and orange. In an especially preferred embodiment, the beverage comprises at least about 85.0% by weight water, based on total weight of the beverage, whereby the water comprises less than about 0.5 ppm of chlorine to assist with, among other things, beverage stability and flavor.

In another especially preferred embodiment, the beverage employed in the beverage product of the present invention comprises from about 0.001 to about 0.5%, and preferably, from about 0.005 to about 0.4%, and most preferably, from about 0.01 to about 0.2% by weight preservative, based on total weight of the beverage, and including all ranges subsumed therein. Typically, such preservatives include food grade preservatives such as those generally classified as benzoates and sorbates, with mixtures of potassium sorbate and benzoate being especially preferred.

Regarding the pressure resistant container that may be used in this invention, such a container is one that may withstand pressurization of at least about 0.5 bars (gauge) at 10° C. Such a pressure resistant container can be metal containing, like an aluminum comprising container or plastic containing, like a polycarbonate or polyester (e.g., polyalkylene terephthalate) comprising container. Often, the container used in this invention is one which is from about 30.0 ml to about 3.0 liters, and preferably, from about 200.0 ml to about 2.0 liters, and most preferably, from about 300.0 ml to about 1.0 liter, including all ranges subsumed therein.

The volume of beverage present in the pressure resistant container typically is from about 30.0% to about 96.0%, and preferably, from about 40.0% to about 95.0%, and most preferably, from about 50.0% to about 90.0% by volume beverage, based on total volume of the pressure resistant container, including all ranges subsumed therein.

The total gauge pressure within the headspace of the pressure resistant container above the beverage is typically from about 0.5 bar to about 25 bars, and preferably, from about 1.0 bar to about 15.0 bars, and most preferably, from about 2.5 bars to about 9.0 bars at about 10.0° C., including all ranges subsumed therein.

Upon taking a drink (i.e., consuming beverage) from the beverage product of the present invention, the final pressure (Pf) within the headspace (within about 1.0 to about 5.0 seconds of taking the drink, in the absence of shaking) of the pressurized vessel and above the beverage will be greater than about atmospheric pressure until substantially all beverage has been consumed. Therefore, the pressure in the headspace of the beverage product will change approximately in accordance with the ideal gas law (assuming about no gas is directly discharged from the headspace) such that:

$$( Pf ) = Pi \cdot \frac{Tf}{Ti} \cdot \frac{V}{V + Δ V}$$

wherein Pf is as previously defined, Pi is the pressure in the headspace prior to the dispensing of effervescent beverage, Ti is the temperature of the gas in the headspace before beverage is dispensed and Tf is the temperature of the gas in the headspace after beverage is dispensed, V is the volume of the head space just before beverage is dispensed and ΔV is the volume of effervescent beverage dispensed out of the beverage product and to the consumer for consumption.

In an especially preferred embodiment, the pressure within the headspace meets the criteria defined above and greater than about 0.05 ml of gas is expelled from the beverage product for about every 1.0 ml of effervescent beverage expelled from the same (when the absolute pressure and temperature outside the beverage product are about 1.0 bar and 10° C., respectively). Therefore, when the valve is opened, the effervescent beverage is discharged or dispensed under pressure, and the beverage product preferably remains pressurized until substantially all beverage has been dispensed from the beverage product.

Regarding the soluble and/or sparingly soluble gas which may be used in the beverage product of the present invention, such a gas is only limited to the extent that it is one which may be used in a beverage consumed by humans. An illustrative list of the gases which may be employed in the present invention includes carbon dioxide, oxygen, nitrogen, nitrous oxide, hydrogen, gaseous hydrocarbon, a noble gas (e.g., argon, helium, neon, krypton) or mixtures thereof, including compressed air. In an especially preferred embodiment, however, the preferred effervescent gas used in this invention is oxygen, or compressed air comprising at least 78.0 percent nitrogen, at least 20.0 percent oxygen, and less than 2.0 percent argon by volume. In another especially preferred embodiment, when the beverage of the present invention is not smooth and silky (e.g., when carbon dioxide is the sole gas employed), the beverage product does not comprise an atomizer.

It is noted herein that if desired, gas adsorbing materials (with or without their own packaging) may be added to the beverage in order to minimize oxidation, or to store extra gas which is released within the product, thereby ensuring that the beverage, when discharged from the beverage product, is effervescent. Moreover, when a more soluble gas is used in a mixture with a less soluble gas, (e.g., when carbon dioxide is employed in a mixture with oxygen), it is generally preferred that the more soluble gas has a partial pressure in the headspace of less than about 5.0 bars, and preferably, not exceeding about 1.0 bar partial at about ambient temperature.

Regarding the valve or dispenser used in the beverage product of the present invention, such a valve often includes, or is associated with, actuator means. There is no limitation with respect to the actuator means that may be used in this invention other than that the actuator means are usable by a consumer for consumption of an effervescent beverage. Typically, an illustrative actuator will be shaped and positioned such that it may be engaged by a consumer's finger, hand, mouth, teeth, or combination thereof in order to deliver effervescent beverage for consumption. Preferably, the actuator means selected will allow for consumption of the beverage by the consumer without requiring the use of at least one hand and a pouring action and a drinking straw and a suckling action.

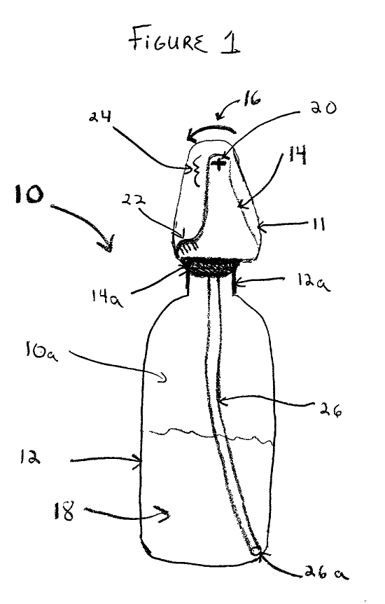

Turning to FIG. 1, an illustrative beverage product 10 is shown with reusable cap 11 in place. The beverage product 10, as illustrated, comprises a container 12, headspace 10a and a dispenser (i.e., aerosol valve), not shown, which is high-throughput and seated beneath actuator means 14 (which is connected to container 12 via actuator means collar 14a). Connected to container 12 at container neck 12a is the dispenser not shown but connected to the container neck 12a by, for example, a crimping technique or screwing mechanism. The dispenser, not shown, is operatively connected to the actuator means 14 such that when cap 11 is removed and when the actuator means 14 is moved from a resting position, as illustrated by arrow 16, the same causes the dispenser not shown to open so that effervescent (and pressurized) beverage 18 may be dispensed to the mouth of a consumer (not shown) through actuator opening 20 illustrated in the shape of a tee or cross. Actuator means 14 may be moved by the consumer by pressing finger-lip 22 (e.g., a portion for contact with a finger) or simply by moving the same by gripping with the mouth, teeth or both (not shown) at actuator mouth portion 24.

Subsequent to moving the actuator means 14 and opening the dispenser or aerosol valve (not shown), effervescent beverage 18 is drawn through dip tube 26 via dip tube opening 26a and dispensed through actuator opening 20 for consumption.

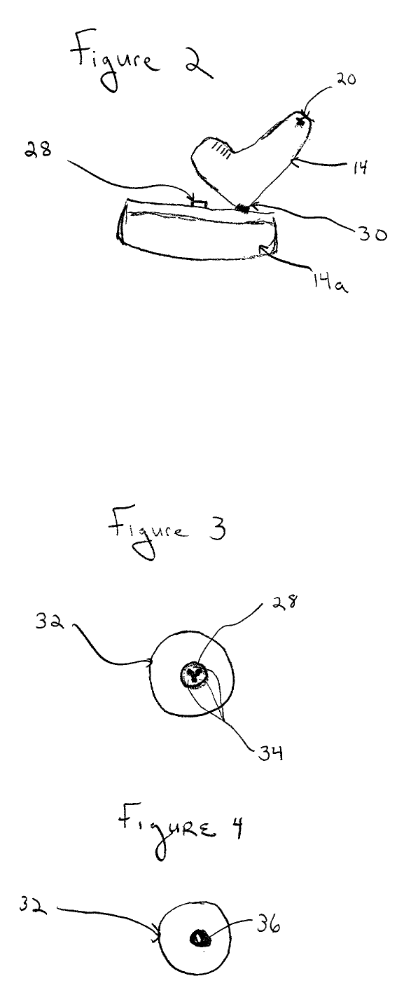

Turning to FIG. 2, actuator means 14 is shown in an open position exposing dispenser nozzle 28. The actuator means 14 is connected to actuator means collar 14a via hinge 30, and rests on dispenser nozzle 28 when operatively connected to the same. FIG. 3 depicts dispenser 32 (top view) with dispenser nozzle 28 having a plurality of effervescent beverage dispensing channels 34. FIG. 4 depicts a bottom view of dispenser 32 with draw nozzle 36. Thus, when actuator means 14 is moved from a resting position, effervescent beverage 18 is dispensed through dip tube 26 which is connected to draw nozzle 36 to thereby transport effervescent beverage through plurality of dispensing channels 34 of dispenser nozzle 28 and through actuator opening 20 for consumption.

It is noted herein that optionally, dispenser 32 may be operatively connected to an atomizer not shown to produce a gas-continuous beverage. Preferably, however, can atomizer is not used and the effervescent beverage of the present invention is water-continuous, especially, when carbon dioxide is employed. Moreover, in an especially preferred embodiment, dip tube opening 26a faces the portion of the container 12 that is on the opposite side of finger-lip 22.

When assembling the beverage product of the present invention, commercially available bottles able to withstand the pressures encountered during the filling process to produce products at the pressures described herein may be used. Such bottles are typically sold by suppliers like CCL Industries, Inc. The aerosol valves (i.e., dispenser) and dip tubes employable in this invention may also be purchased commercially, although aerosol valves with a plurality of dispensing channels are often preferred. Furthermore, the actuator means may be purchased commercially; however, a preferred actuator is oval-like, having a top portion (i.e., portion with the actuator opening) with dimensions that are from about 0.20 cm to about 3.0 cm by 0.05 cm to about 2.5 cm, including all ranges subsumed therein. At the time of assembly, in no particular order, the desired beverage is fed into the bottle, the valves are fastened on to the bottles and the predetermined gas is fed into the bottle through the valve. Optionally, the gas may be added in the form of a liquefied propellant.

The following examples are provided to facilitate an understanding of the present invention. The examples are not intended to limit the scope of the accompanying claims.

### EXAMPLE 1

Water (300 ml) at 10±0.50° C. was poured into a strong polyethylene terephthalate (“PET”) bottle of 28 g mass and 520 ml brimful capacity. The bottle was then left to equilibrate in a temperature-controlled bath also at 10±0.5° C. The headspace above the water in the bottle was flushed with oxygen for 5 to 10 seconds, and then the aerosol valve was placed quickly over the neck of the bottle, thus sealing the bottle from any loss of oxygen or influx of air. The aerosol valve was then held firmly in place by means of a screw cap with a small hole cut in the center in order to allow the stem of the valve to be accessible.

More oxygen was then added from the regulated supply oxygen through the stem of the aerosol valve until a pressure of about 4 bar was reached. The bottle was then shaken to ensure that the gas inside was at the same temperature as the water, and the bottle was topped up to about 4 bar with more oxygen. This was necessary because the temperature of the gas when first injected into the bottle is somewhat higher than 10° C.

The sealed and pressurized bottle was then placed in a temperature controlled bath at 10±0.5° C. for 5 minutes to equilibrate, the sample being shaken every 30 seconds to ensure good contact between the gas mixture and the water in the bottle.

Subsequent to the bubbles, resulting from the shaking, rising to the surface, the beverage was then discharged under water that was at a temperature of 21±10° C. The stream of discharged fluid was observed as it left the bottle against a black plastic sheet, and it was noted whether or not there was a visible, fine, smoke-like effervescence.

### EXAMPLE 2

Beverages were prepared by mixing, in no particular order, the following components:

| Ingredient | Weight Percent (%) |
|---|---|
| Potassium Sorbate | 0.005-0.06 |
| Potassium Benzoate | 0.01-0.03 |
| Sodium hexametaphosphate | 0.02-0.1 |
| Chelator (EDTA) | 0.001-0.03 |
| Sugar | 4.0-6.0 |
| Flavor* | 0.01-0.1 |
| Citric Acid | 0.10-0.20 |
| Water | Balance |

*Commercially available beverage flavor, like passion fruit or peach flavor.

The beverages of Example 2 were added to a container in a manner similar to the one described in Example 1 to produce effervescent beverages having fruit flavors.

What is claimed:

1. A pressurized beverage product comprising:
(a) a beverage within a pressure resistant container, the beverage comprising a soluble gas, a sparingly soluble gas, or a mixture of gases dissolved therein; and
(b) a valve in a position to seal the container, the valve, when opened, suitable to dispense the beverage as an effervescent beverage to a mouth of a consumer
wherein, internally, the container has a headspace pressurized to less than about 25 bar, gauge, with the soluble gas, sparingly soluble gas, or mixture of gases.

2. The pressurized beverage product according to claim 1 wherein the beverage comprises oxygen, nitrogen, or a mixture thereof.

3. The pressurized beverage product according to claim 1 wherein the beverage comprises oxygen, compressed air or a mixture thereof.

4. The pressurized beverage product according to claim 3 wherein the compressed air comprises at least 78.0% nitrogen, at least 20.0% oxygen, and less than 2.0% argon.

5. The pressurized beverage product according to claim 1 wherein the pressurized beverage product is pressurized from about 1.0 bar to about 15.0 bar, gauge.

6. The pressurized beverage product according to claim 1 wherein the pressurized beverage product comprises water with less than about 0.5 ppm chlorine.

7. The pressurized beverage product according to claim 1 wherein the beverage is juice, tea, coffee, an alcoholic drink, a diet drink, a protein-based drink, soda, or a pharmaceutical or medicinal drink.

8. The pressurized beverage product according to claim 7 wherein the beverage is a citrus beverage.

9. The pressurized beverage product according to claim 8 wherein the citrus beverage is free of pulp.

10. The pressurized beverage product according to claim 1 wherein the beverage comprises suspended bubbles and at least 80% of the suspended bubbles have a diameter that is less than about 0.5 mm.

11. The pressurized beverage product according to claim 1 wherein the beverage is liquid-continuous.

12. The pressurized beverage product according to claim 1 wherein the beverage is water-continuous.

13. The pressurized beverage product according to claim 1 wherein the container has a volume from about 30.0 ml to about 3.0 liters and the volume is occupied with about 96.0% beverage.

14. The pressurized beverage product according to claim 1 wherein the beverage is smooth and silky upon consumption.

15. A method for consuming a beverage comprising the steps of:
(a) contacting an actuator of a pressurized beverage product with a mouth of a consumer; and
(b) moving the actuator from a resting position to release beverage out of the beveraged product and into the mouth of the consumer, the beverage being effervescent and comprising suspended bubbles wherein at least 80% of the suspended bubbles have a diameter that is less than about 0.5 mm.

16. The method for consuming a beverage according to claim 15 wherein the beverage product has a pressurized headspace and pressure in the headspace changes about in accordance with the ideal gas law wherein:
$$( Pf ) = Pi \cdot \frac{Tf}{Ti} \cdot \frac{V}{V + Δ V}$$
and Pf is headspace final pressure, Pi is headspace pressure before beverage is released, Ti is gas temperature in the headspace before beverage is released, Tf is gas temperature in the headspace after beverage is released, V is volume in the headspace before beverage is released and ΔV is volume of beverage released from the beverage product.

17. The method for consuming a beverage according to claim 16 wherein greater than about 0.05 ml of gas is expelled from the beverage product for about every 1.0 ml of beverage.

18. The method for consuming a beverage according to claim 15 wherein the beverage is juice, tea, coffee, an alcoholic drink, a diet drink, a protein-based drink, soda, or a pharmaceutical or medicinal drink.

19. The method for consuming a beverage according to claim 15 wherein the beverage is:
(a) smooth and silky, or
(b) consumed without using at least one hand and a pouring action or a drinking straw and a suckling action, or
(c) both (a) and (b).

20. The method for consuming a beverage according to claim 15 wherein the beverage is consumed without requiring a hand squeezing action on a container.

21. A method for consuming a beverage comprising the steps of:
(a) contacting an actuator of a pressurized beverage product with a mouth of a consumer;
(b) moving the actuator from a resting position to release beverage out of the beverage product and into the mouth of the consumer
wherein the beverage product comprises a container and, internally, the container has a headspace pressurized to less than abut 25 bar, gauge, with the soluble gas, sparingly soluble gas, or mixture thereof.
